(19) United States
(12) Patent Application Publication
(10) Pub. No.: US 2025/0223173 A1
(43) Pub. Date: Jul. 10, 2025

(54) METHOD FOR PREPARING GRAPHENE NANOPLATELETS BASED SOLUBLE OIL FOR AAC BLOCK

(71) Applicant: NANOSPAN INDIA PRIVATE LIMITED, Hyderabad (IN)

(72) Inventors: Venkataramana Gedela, Hyderabad (IN); Ravi Kanth Nuguru, Hyderabad (IN); Ashok Chinthakuntla, Nalgonda (IN); Praveen Kumar Jella, Nalgonda (IN)

(73) Assignee: NANOSPAN INDIA PRIVATE LIMITED, Hyderabad (IN)

(21) Appl. No.: 19/008,705

(22) Filed: Jan. 3, 2025

(30) Foreign Application Priority Data
Jan. 4, 2024 (IN) 202441000818

(51) Int. Cl. C01B 32/194; C04B 14/02

(52) U.S. Cl. CPC C01B 32/194; C04B 14/026; C01P 2004/17

(57) ABSTRACT

A method for preparing a graphene nanoplatelets (GNP) based soluble oil for an AAC (Autoclaved Aerated Concrete) block is disclosed. The method comprises, preparing a first batch of a soluble oil, preparing a second batch of the soluble oil, mixing the first batch of the soluble oil with the second batch of the soluble oil to obtain a second mixture, adding a tri-sodium orthophosphate solution to the second mixture to obtain a third mixture, adding graphene nanoplatelets to the third mixture to obtain a fourth mixture, and obtaining the GNP based soluble oil by adding a water-soluble acrylic resin solution to the fourth mixture.

### BACKGROUND

Unless otherwise indicated herein, the materials described in this section are not prior art to the claims in this application and are not admitted to being prior art by inclusion in this section.

### FIELD OF THE INVENTION

The subject matter in general relates to additives for concrete. More particularly, but not exclusively, the subject matter relates to a method for preparation of graphene based additives for concrete such as Autoclaved Acrated Concrete (AAC) blocks.

### DISCUSSION OF THE RELATED ART

Conventionally, concrete in the form of concrete blocks is utilized as a primary component in the construction industry due to its strength and durability. The primary ingredients of concrete blocks are cement, aggregates such as sand, gravel, and water. Although the concrete blocks are strong, they have a porous structure which allows the water to penetrate. Further, the concrete blocks are lightweight but possess low mechanical properties such as compressive strength, tensile strength, and modulus of elasticity. Additionally, the manufacture, construction, and infrastructure development using the concrete blocks contribute to about 4-8% of global carbon emissions. These regular concrete blocks shortcomings have led to the development of Autoclaved Acrated Concrete (AAC) blocks, which primarily comprise cement, lime, fly ash, sand, water, and aluminium powder.

In the conventional AAC blocks, the cement is the main element for achieving compressive strength in these AAC blocks. To achieve the same, there is a need to increase the percentage of cement in AAC blocks. Though increasing the cement percentage may result in better reaction between calcium in lime, silica in fly ash, and water, due to the presence of a high percentage of cement, reactions may occur that may further cause breakage in the AAC blocks.

Additionally, the conventional AAC blocks have low load-bearing capabilities and therefore need additional support. Further, AAC blocks possess porous structures due to which water absorption by these AAC blocks tends to be high.

Conventionally, in the AAC manufacturing process, fly ash is used and reactivity levels of fly ash fluctuate from batch to batch. To maintain the compressive strength of these AAC blocks, there is a need to strike a balance between calcium, silica, and water. Though fly ash is a reliable raw material in recent times it has become a major concern due to the usage of lower-grade fly ash (known as pond ash). This lower-grade pond ash contains unburned carbon which increases Loss-Of-Ignition (LOI) levels. Further, the silica content in this low-grade fly ash is low, which alters the crucial calcium and silica ratio that ensures the compressive strength in AAC blocks. Further, the increase in LOI levels causes the breakage of AAC blocks due to the presence of a high amount of unburned carbon and other residues, thereby increasing the percentage of cement in AAC blocks.

Furthermore, despite advances in AAC manufacturing, the conventional chemical admixtures are still limited and lack the potential to address the foregoing shortcomings in AAC blocks.

In view of the forging discussion, there is a need to address these challenges and provide a technical solution to increase compressive strength and reduce water absorption in AAC blocks.

### SUMMARY

In an aspect, a method for preparing a soluble oil for an AAC (Autoclaved Acrated Concrete) block comprises, preparing a metal hydroxide solution, adding the prepared metal hydroxide solution to an acid slurry solution to obtain a first solution, preparing a metal hydroxide aqueous solution and mixing the metal hydroxide aqueous solution with the first solution to obtain the soluble oil.

In another aspect, a method for preparing a graphene nanoplatelets (GNP) based soluble oil for an AAC (Autoclaved Acrated Concrete) block is disclosed. The method comprises, preparing a first batch of a soluble oil, preparing a second batch of the soluble oil, mixing the first batch of the soluble oil with the second batch of the soluble oil to obtain a second mixture, adding a tri-sodium orthophosphate solution to the second mixture to obtain a third mixture, adding graphene nanoplatelets to the third mixture to obtain a fourth mixture, and obtaining the GNP based soluble oil by adding a water-soluble acrylic resin solution to the fourth mixture.

In an aspect, an AAC block is disclosed. The AAC block comprises cement in the range of 150-335 Kg/L, lime in the range of 95-240 Kg/L, fresh slurry in the range of 1320-2200 Kg/L, return slurry in the range of 450-800 Kg/L, fresh slurry dry in the range of 879-1500 Kg/L, return slurry dry in the range of 251-375 Kg/L, gypsum in the range of 20-25 Kg/L, aluminum in the range of 0.8-2.1 Kg/L, water in the range of 0-36 Kg/L, soluble oil in the range of 0-2 Kg/L; and graphene nanoplatelets based soluble oil in the range of 1-1.5 Kg/L.

### BRIEF DESCRIPTION OF DRAWINGS

This disclosure is illustrated by way of example and not limitation in the accompanying figures. Elements illustrated in the figures are not necessarily drawn to scale, in which like references indicate similar elements and in which:

FIG. 1 illustrates a method 100 to prepare a soluble oil for concrete such as AAC blocks, in accordance with embodiment;

FIG. 2 is a flowchart illustrating a method 200 of preparation of the graphene nanoplatelets (GNP) based soluble oil, in accordance with an embodiment;

FIG. 3A illustrates a first Field Emission Scanning Electron Microscopy (FESEM) image 300 of AAC blocks without graphene nanoplatelets (GNP) based soluble oil, in accordance with an embodiment;

FIG. 3B illustrates a second FESEM image 350 of AAC blocks with graphene nanoplatelets (GNP) based soluble oil, in accordance with an embodiment;

FIG. 4A illustrates a third FESEM image 400 of AAC blocks without graphene nanoplatelets (GNP) based soluble oil, in accordance with an embodiment;

FIG. 4B illustrates a fourth FESEM image 450 of AAC blocks with graphene nanoplatelets (GNP) based soluble oil, in accordance with an embodiment;

FIG. 5A illustrates a graph 500 representing an X-ray diffraction (XRD) pattern of AAC blocks without the graphene nanoplatelets (GNP) based soluble oil, in accordance with an embodiment; and

FIG. 5B illustrates a graph 550 representing an XRD pattern of AAC blocks with the graphene nanoplatelets (GNP) based soluble oil, in accordance with an embodiment.

### DETAILED DESCRIPTION OF THE INVENTION

The following detailed description includes references to the accompanying drawings, which form part of the detailed description. The drawings show illustrations in accordance with example embodiments. These example embodiments are described in enough detail to enable those skilled in the art to practice the present subject matter. However, it may be apparent to one with ordinary skill in the art that the present invention may be practised without these specific details. In other instances, well-known methods, procedures and components have not been described in detail so as not to unnecessarily obscure aspects of the embodiments. The embodiments can be combined, other embodiments can be utilized, or structural and logical changes can be made without departing from the scope of the invention. The following detailed description is, therefore, not to be taken in a limiting sense.

In this document, the terms “a” or “an” are used, as is common in patent documents, to include one or more than one. In this document, the term “or” is used to refer to a non-exclusive “or”, such that “A or B” includes “A but not B”, “B but not A”, and “A and B”, unless otherwise indicated.

The embodiments disclose an additive that may be used in concrete structures such as AAC (autoclaved aerated concrete) blocks. The additive is a graphene nanoplatelets (GNP) based soluble oil that may be utilized in AAC blocks to improve the compressive strength, reduction in water absorption and block dry density in AAC blocks.

In an embodiment, the additive may comprise a first additive which is used in the preparation of graphene nanoplatelets (GNP) based soluble oil. In an embodiment, the first additive may be a soluble oil.

In an embodiment, GNP refers to nanoscale platelet-shaped particles consisting of several layers of graphene. The GNP may have a two-dimensional carbon structure.

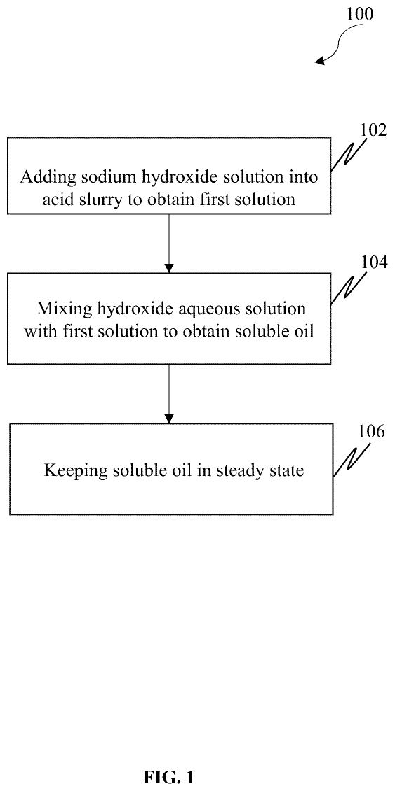

Referring to the figures, and more particularly to FIG. 1, is a flowchart that illustrates a method 100 to prepare the soluble oil for concrete such as AAC blocks. At step 102, a metal hydroxide solution may be prepared and added into an acid slurry to obtain a first solution. The first solution is kept at a steady state without disturbing till the first solution reaches the ambient room temperature. The first solution may take about 30 minutes to reach the ambient room temperature.

In an embodiment, the steady state refers to a state in which any mixture is left undisturbed to attain ambient temperature.

In an embodiment, the metal hydroxide solution may be selected from a group consisting of sodium hydroxide solution, and calcium hydroxide solution, among other metal hydroxide solutions.

In an embodiment, the metal hydroxide solution includes the sodium hydroxide solution and the acid slurry solution in a ratio of 1:3.

In an embodiment, the metal hydroxide solution includes the sodium hydroxide solution and the acid slurry solution in a ratio of 1:2.

In an embodiment, the metal hydroxide solution includes the sodium hydroxide solution and the acid slurry solution in a ratio of 1:2.5.

At step 104, 10-15% of a metal hydroxide aqueous solution is prepared and mixed with the first solution to obtain the soluble oil. The metal hydroxide aqueous solution contains 10-15% of the metal hydroxide by weight and the rest 85-90% may be water. The metal hydroxide is mixed with the first solution in a mixer, preferably, at a speed of 100 rpm.

In an embodiment, the metal hydroxide aqueous solution may be selected from a group consisting of sodium hydroxide aqueous solution, and calcium hydroxide aqueous solution, among other metal hydroxide aqueous solutions.

At step 106, the first solution may be kept in a steady state for 15 minutes.

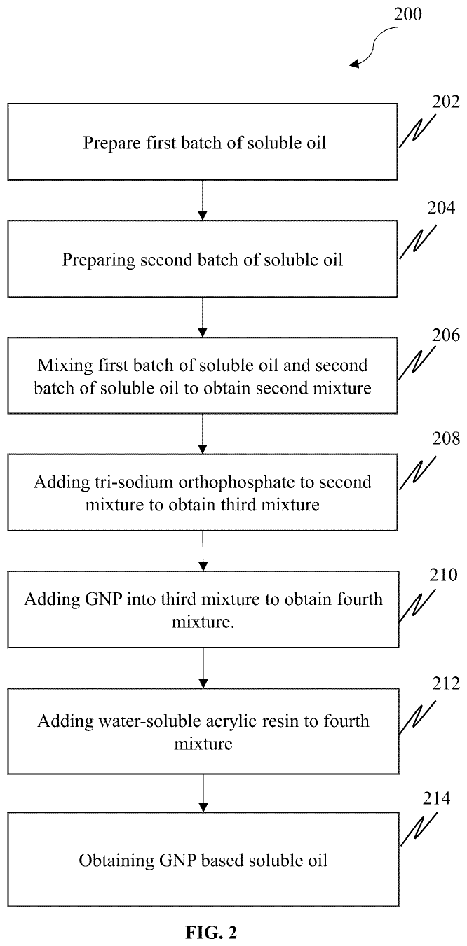

FIG. 2 is a flowchart illustrating a method 200 of preparation of the graphene nanoplatelets (GNP) based soluble oil, in accordance with an embodiment.

At step 202, the soluble oil is continuously mixed, referred hereinafter as a first batch of the soluble oil. The first batch of the soluble oil is mixed preferably for around 5 minutes at a speed of 100 rpm.

In an embodiment, the mixing of the metal hydroxide solution (base) with acid slurry solution (acid) is a exothermic reaction, and in order to control the increased temperature between the acid and the base, mixing of the metal hydroxide solution with acid slurry solution is again performed preferably for 5-15 minutes.

At step 204, a second batch of the soluble oil is prepared in similar manner that is used in steps 102-106.

At step 206, the first batch of the soluble oil (obtained at step 202) is mixed continuously with the second batch of the soluble oil. The first batch of the soluble oil and the second batch of the soluble oil to obtain a second mixture. Preferably, the first batch of the soluble oil and the second batch of the soluble oil is mixed for around 10 minutes at a speed of 150 rpm.

At step 208, tri-sodium orthophosphate solution is added to the second mixture. Preferably, the amount of the tri-sodium orthophosphate solution is 2-4% by weight of the second mixture. The tri-sodium orthophosphate solution is continuously mixed with the second mixture for preferably around 10 minutes to maintain a speed of 200 rpm to obtain a third mixture.

At step 210, graphene nanoplatelets (GNP) are added into the third mixture. Preferably, the amount of the GNP is 10-15% by weight of the third mixture. The GNP is mixed with the third mixture preferably for around 30-45 minutes to maintain a speed of 250 rpm to obtain a fourth mixture.

At step 212, the fourth mixture may be at a steady state preferably for 15 minutes, and thereafter, a uniform solution of a water-soluble acrylic resin is prepared and mixed with the fourth mixture. Preferably, the amount of the water-soluble acrylic resin is 15-20% by weight of the fourth mixture. The mixing may be performed preferably for around 30-45 minutes to maintain a speed of 300 rpm.

At step 214, the resultant mixture is obtained by keeping the fourth mixture in the steady state until it attains uniformity and turns into a uniform greyish coloured solution or oil.

In an embodiment, the graphene nanoplatelets (GNP) based soluble oil approximately has 75-80% of the first additive (soluble oil), 5-10% of graphene platelets and 10-15% of water-soluble acrylic resin-based polymer.

All the above discussed steps 202-214 are maintained at room temperature and atmospheric pressure.

In an embodiment, the obtained additive, i.e., GNP based soluble oil may be utilized as an additive in the manufactured AAC blocks, and the GNP based AAC blocks may be subjected for testing to assess their compressive strength, water absorption, and block dry density.

A test is conducted with 335 kgs of cement in the case of GNP based AAC block, and 385 kgs of cement for a regular AAC block. Table 1.1 represents a first test result data set of GNP based AAC block presented hereunder:

| | Weight | |
|---|---|---|
| S. | of sample | Compressive strength |

| No | (kg) | Top | Middle | Bottom | Average |
|---|---|---|---|---|---|
| 1 | 9.02 | 4.45 | 4.80 | 4.90 | 4.72 |
| 2 | 9.03 | 4.20 | 4.30 | 5.50 | 4.67 |
| 3 | 8.96 | 3.95 | 4.30 | 4.75 | 4.33 |
| 4 | 14.11 | 3.91 | 4.10 | 4.91 | 4.31 |

Table 1.2 represents the first test result data set of a regular AAC block without using GNP, presented hereunder:

| | Weight | |
|---|---|---|
| S. | of sample | Compressive strength (MPa) |

| No | (kg) | Top | Middle | Bottom | Average |
|---|---|---|---|---|---|
| 1 | 9.23 | 3.20 | 4.50 | 5.00 | 4.23 |
| 2 | 14.11 | 3.64 | 4.08 | 4.82 | 4.18 |

The tables 1.1 and 1.2 depict compressive strengths of the regular AAC blocks and the graphene based AAC blocks. For instance, a test sample in Table 1.1 comprising the graphene based AAC block, weighing about 9.02 kgs has an average compressive strength of 4.72. Whereas the test sample of a similar weight (9.23 kgs) regular AAC block showed lower average compressive strength of 4.23 MPa. Further, the amount of cement required by the GNP based block is significantly lower compared to a regular AAC block.

Table 2.1 represents a second test data set of the regular AAC block and GNP based AAC block presented below:

| | Regular AAC block | GNP based AAC block |
|---|---|---|
| Materials | (Kg/Litre) | (Kg/Litre) |
| Cement | 200 | 150 |
| Lime | 120 | 120 |
| Total binder | 345 | 295 |
| Fresh slurry | 1300 | 1320 |
| Returns slurry | 223.7 | 450 |
| Fresh slurry dry | 866.0 | 879.3 |
| Returns slurry dry | 223.7 | 251.6 |
| Gypsum | 25 | 25 |
| Aluminium | 0.85 | 0.80 |
| Water | 50 | 0 |
| Soluble oil | 3.00 | 2.00 |
| GNP based soluble oil | — | 1.00 |
| Total batch | 2095 | 2065 |
| Total solids | 1434.69 | 1425.97 |
| Total water | 660.31 | 639.03 |
| Total wet density | 805.77 | 794.23 |
| Total dry density | 551.80 | 548.45 |
| Water to powder ratio | 0.46 | 0.448 |

Compressive strength MPa

| | | |
|---|---|---|
| Top | 4.82 | 4.57 |
| Middle | 5.01 | 5.06 |
| Bottom | 5.50 | 5.55 |
| Average | 5.11 | 5.16 |

The table 2.1 depicts compressive strengths of the regular AAC block and the graphene based AAC block. For instance, a test sample of the regular AAC block comprising 200 kgs of cement shows a compressive strength of 5.11 MPa. Whereas a test sample of the graphene based AAC block comprising just 150 kgs of cement shows a higher compressive strength of 5.16 MPa than that of the regular AAC block.

Table 3 represents a third test data set of the regular AAC block and GNP based AAC block presented below:

| | Regular AAC block | GNP based AAC block |
|---|---|---|
| Materials | (Kg/L) | (Kg/L) |
| Cement | 400 | 350 |
| Lime | 95 | 95 |
| Total binder | 515 | 465 |
| Fresh slurry | 2150 | 2210 |
| Returns slurry | 650 | 650 |
| Fresh slurry dry | 1431.9 | 1471.9 |
| Returns slurry dry | 357.5 | 357.5 |
| Gypsum | 20 | 20 |
| Aluminium | 1.14 | 1.14 |
| Water | 40 | 0 |
| Soluble oil | 2.00 | 1.00 |
| Water to powder ratio | 0.47 | 0.45 |
| GNP based soluble oil | — | 1.00 |

Compressive strength MPa

| | | |
|---|---|---|
| Top | 4.8 | 5.18 |
| Middle | 4.93 | 5.26 |
| Bottom | 5.16 | 5.6 |
| Average | 4.96 | 5.33 |

The table 3 depicts compressive strengths of the regular AAC block and the graphene based AAC block. For instance, a test sample of the regular AAC block comprising 400 kgs of cement shows a compressive strength of 4.96 MPa. Whereas a test sample of the graphene based AAC block comprising 350 kgs of cement shows a higher compressive strength of 5.33 MPa than that of the regular AAC block.

Table 4 represents a fourth test data including compressive strengths of a regular AAC block and GNP based AAC block presented below:

| | Regular AAC block | Graphene based AAC block |
|---|---|---|
| Materials | (Kg/L) | (Kg/L) |
| Fresh slurry | 2100 | 2200 |
| Returns slurry | 500 | 600 |
| Cement | 410 | 410 |
| Lime | 165 | 165 |
| Gypsum | 15 | 20 |
| Aluminium | 1.68 | 1.68 |
| DC | 10 | 10 |
| Soluble oil | 3.0 | 2 |
| GNP based soluble | 0 | 1 |
| oil | | |
| Water | 90 | 10 |
| Density | 703 | 753 |
| Compressive | 3.5 | 5.3 |
| strength | | |

The table 4 depicts compressive strengths of the regular AAC block and the graphene based AAC block. For instance, a test sample of the regular AAC block comprising 410 kgs of cement shows a compressive strength of 3.5 MPa. Whereas a test sample of the graphene based AAC block comprising similar amount 410 kgs of cement shows significantly higher compressive strength of 5.3 MPa than the regular AAC block.

Table 5 represents a fifth test data including compressive strengths of a regular AAC block and GNP based AAC block presented below:

| | Regular AAC block | GNP based AAC block |
|---|---|---|
| Materials | (Kg/L) | (Kg/L) |
| Fly ash slurry density | 1.49 | 1.49 |
| Return slurry density | 1.43 | 1.43 |
| Fly ash slurry | 2500 | 2500 |
| Return slurry | 800 | 800 |
| Fly ash dry | 1581 | 1581 |
| Return dry | 463 | 463 |
| Wonder cement | 375 | 335 |
| Lime | 240 | 240 |
| POP | 25 | 25 |
| Aluminium powder | 2.1 | 2.1 |
| Soluble oil | 1 | 0 |
| Total dry solid | 2686 | 2646 |
| Extra water | 36 | 36 |
| GNP based soluble | 0 | 1.5 |
| oil | | |
| Hardner | 1 | 0 |
| Binders | 640 | 600 |
| Compressive | 3.48 | 3.51 |
| strength | | |

In an embodiment, the table 5 depicts compressive strengths of the regular AAC block and the graphene based AAC block. For instance, a test sample of the regular AAC block comprising 375 kgs of cement shows a compressive strength of 3.48 MPa. Whereas a test sample of the graphene based AAC block comprising significantly lesser amount, i.e., 335 kgs of cement shows higher compressive strength of 3.51 MPa than the regular AAC block.

| | | | Compres- | Aver- | |
|---|---|---|---|---|---|
| | | Test Piece | sive | age | |
| Sl. | | Dimensions | Strength | (N/ | Test |
| No. | Identification | (mm) | (N/mm²) | mm²) | Method |
| 1 | Regular | 150.0 × 151.0 × 151.0 | 4.1 | 4.4 | IS |
| 2 | AAC block | 151.0 × 150.0 × 150.0 | 4.7 | | 6441: |
| 3 | | 150.0 × 151.0 × 150.0 | 4.4 | | Part 5: |
| 4 | GNP based | 151.0 × 150.0 × 150.0 | 6 | 6.0 | 1972 |
| 5 | AAC block | 150.0 × 150.0 × 150.0 | 6.2 | | (RA |
| 6 | | 151.0 × 151.0 × 150.0 | 5.8 | | 2017) |

The table 6 depicts compressive strengths of the regular AAC block and the graphene based AAC block. It was found in the test that, the test piece of the regular AAC block shows lesser compressive strength of 4.4 N/mm² than the graphene based AAC block which possessed significantly greater compressive strength of 6.0 N/mm².

A sample of the regular AAC block and a sample of the graphene based AAC block are tested to assess their respective water absorption capabilities. The sample of the regular AAC block and the sample of the graphene based AAC block were subjected to a test method of: IS 6598-2018.

Table 7 represents a seventh test data including water absorption percentages of the regular AAC block and the GNP based AAC block, presented below:

| | | | | Average | |
|---|---|---|---|---|---|
| | | | Water | Water | |
| | | Test Piece | Absorp- | Absorp- | |
| Sl. | | Dimensions | tion | tion | Test |
| No. | Identification | (mm) | (%) | (%) | Method |
| 1 | Regular | 163 × 41 × 41 | 37.1 | 36.9 | IS 6598 - |
| 2 | AAC block | 162 × 41 × 40 | 37.2 | | 2018 |
| 3 | | 163 × 40 × 41 | 36.5 | | |
| 4 | GNP based | 163 × 41 × 42 | 35.1 | 34.5 | |
| 5 | AAC block | 163 × 41 × 41 | 34.6 | | |
| 6 | | 163 × 42 × 42 | 33.8 | | |

From the above tabulated data, it was found out that, the test sample of the regular AAC block possessed significantly higher water absorption percentage of 36.9% with respect to volume of water or weight than that of the graphene based AAC block which showed significantly lower water absorption of 34.5%.

Further, in an embodiment, a sample of the regular AAC block and a sample of the graphene based AAC block may be tested to assess their respective block dry densities. The samples of the regular AAC block sample and the sample of the graphene based AAC block were subjected to a test method of: IS 6441: Part 1:1972 RA 2017.

Table 8 represents an eighth test data including block dry densities of the regular AAC block and the GNP based AAC block, presented below:

| | | | Block Dry | | |
|---|---|---|---|---|---|
| | | Test Piece | Density | Average | |
| Sl. | | Dimensions | (Kg/ | (Kg/ | Test |
| No. | Identification | (mm) | Cu · m) | Cu · m) | Method |
| 1 | Regular | 199 × 105 × 43 | 643 | 638 | IS 6441: |
| 2 | AAC block | 199 × 105 × 45 | 641 | | Part 1: |
| 3 | | 200 × 105 × 44 | 630 | | 1972 RA |
| 4 | GNP based | 201 × 104 × 44 | 635 | 628 | 2017 |
| 5 | AAC block | 201 × 105 × 43 | 624 | | |
| 6 | | 201 × 104 × 43 | 624 | | |

From the above tabulated data, it was found out that, the test sample of the regular AAC block showed a significantly higher block dry density of 638 kg/cu·m than that of the graphene based AAC block which showed significantly lesser block dry density of 628 kg/cu·m.

Therefore, from the test data it is quite evident that, the graphene nanoplatelets (GNP) based soluble oil when utilized in the AAC blocks, can significantly achieve a reduction in water absorption, enhancement in the compressive strength. Further, the graphene nanoplatelets (GNP) based soluble oil can further improve fire resistance capabilities of the AAC blocks. The soluble oil thus prepared using nanostructured materials (GNP) provides higher compressive strength, reduces block dry density, avoid internal and external cracks, and reduces water absorption of the AAC blocks.

In an embodiment, the AAC block comprising the GNP based soluble oil comprises nanosized calcium silicate hydrate (CSH) microstructures. The nanosized CSH microstructures formed comprises a rod-like morphology. The formation of these CSH microstructures increases the compressive strength of the AAC blocks and reduces the water absorption in the AAC blocks.

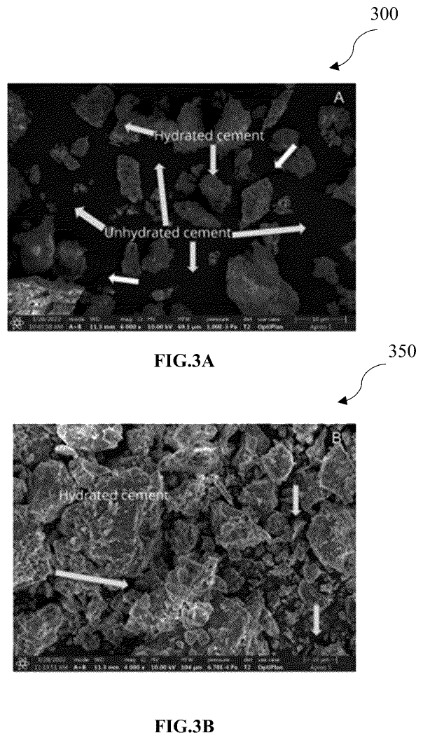

FIG. 3A illustrates a first Field Emission Scanning Electron Microscopy (FESEM) image 300 of AAC blocks without graphene nanoplatelets (GNP) based soluble oil, in accordance with an embodiment. The FESEM image 300 may indicate a particle-like morphology of calcium silicate hydrate (CSH). The morphology may also indicate a less organised-crystalline microstructural development. The particle-type morphology shows limited optimization of the growth environment for CSH formation.

In the FESEM image 300, the bright (grey) regions represent the presence of calcium silicate hydrate (CSH) and hydration of the cement. A hydration level in the regular AAC block (without the use of graphene based soluble oil) is observed to be approximately around 60-65%.

FIG. 3B illustrates a second FESEM image 350 of AAC blocks with graphene nanoplatelets (GNP) based soluble oil, in accordance with an embodiment. The FESEM image 400 represents a morphology of the graphene nanoplatelets (GNP) based AAC blocks. The bright (grey) regions represents the presence of calcium silicate hydrate (CSH) and hydration of the cement. The hydration level in the GNP based AAC block is observed to be approximately around 95%. Therefore, the AAC blocks with GNP based soluble oil exhibit a higher degree of hydration and superior structural integrity compared to regular AAC blocks thereby enhancing the material properties of the AAC blocks. The increased hydration may further result in faster cutting time.

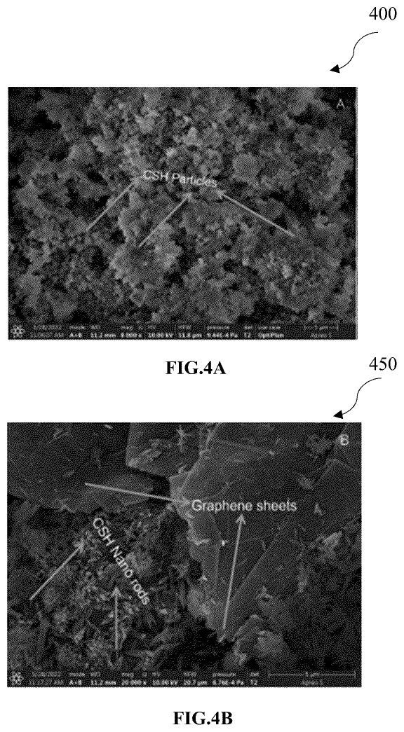

FIG. 4A illustrates a third FESEM image 400 of AAC blocks without graphene nanoplatelets (GNP) based soluble oil, in accordance with an embodiment. The presence of CSH may be depicted by the bright (grey) regions in the FESEM image 400. The CSH in the third FESEM image 400 exhibits a particle-like morphology, indicating a less organized and less crystalline microstructural development. This particle-type morphology suggests limited optimization of the growth environment for CSH formation.

FIG. 4B illustrates a fourth FESEM image 450 of AAC blocks with graphene nanoplatelets (GNP) based soluble oil, in accordance with an embodiment. The FESEM image 450 may represent a morphology of the graphene nanoplatelets (GNP) based AAC blocks. The fourth FESEM image 450 depicts a formation of nanosized CSH structures with a needle-like or rod-like morphology. Additionally, graphene nanoplatelets sheets that are introduced through the soluble oil are evident in microstructures (CSH nano rods/needles and graphene nanoplatelets sheets). The graphene nanoplatelet sheets may act as nucleation sites that may facilitate the growth of CSH needles and rods like microstructures. This may indicate that there is a completion of chemical reaction thereby resulting in improved microstructural formations. Therefore, the formation of microstructures in the AAC blocks with GNP based oil, results in enhanced compressive strength. Further, graphene nanoplatelets sheets may promote well-organized interconnected structure and growth in mechanism.

In an embodiment, the AAC block comprises fly ash and the cement. The fly ash and the cement comprise silica. The GNP based soluble oil converts the silica present in the cement and the fly ash into a calcium silicate hydrate (CSH) which thereby increase the compressive strength of the AAC block and to reduce water absorption in the AAC block.

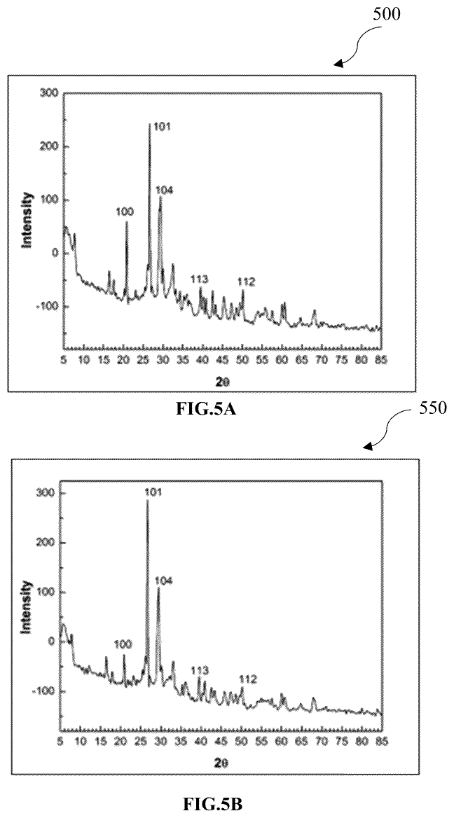

FIG. 5A illustrates a graph 500 depicting an X-ray diffraction (XRD) pattern and peaks of AAC blocks without the graphene nanoplatelets (GNP) based soluble oil, in accordance with an embodiment. The XRD may be a well-known practised technique that may be utilized currently to which may be used to characterize the crystalline structure of the material. The graph 500 may depict diffraction angles represented as “20” on X-axis, and corresponding intensities of silica and calcium in AAC blocks represented as “intensity” on Y-axis. In the graph 500, the XRD pattern of the AAC block without the GNP based soluble oil shows characteristics peaks at 21° (100), 26° (101), 50° (112) indicating the presence of crystalline silica (quartz). Further, characteristics peaks at 29.3° and 39.4° indicate the presence of calcium carbonate. Further, the most prominent peak at 29.6° indicates the presence of calcium silicate hydrate (CSH).

FIG. 5B illustrates a graph 550 depicting an XRD pattern and peaks of AAC blocks with the graphene nanoplatelets (GNP) based soluble oil, in accordance with an embodiment. The graph 550 may depict diffraction angles represented as “20” on X-axis, and corresponding intensities of silica and calcium in AAC blocks represented as “intensity” on Y-axis. In the graph 550, the XRD pattern of the AAC block with the GNP based soluble oil also shows same characteristics peaks confirming the presence of crystalline silica, calcium carbonate and CSH. However, significant differences in the intensity of the major peaks were observed. The intensity of the CSH peak at 29.6° CSH is notably higher in the AAC block with GNP based soluble oil as compared to the regular AAC block without the use of GNP based oil. This indicates a greater extent of CSH formation. Conversely, the intensity of the quartz peak 21° is notably lower in the AAC block with GNP based soluble oil, indicating enhanced conversion of quartz silica (SiO₂) into CSH.

The GNP based AAC blocks of the current invention offer several advantages. The GNP based AAC blocks aid in improving compaction in the AAC blocks by filling up pores of the AAC blocks, thereby enhancing the nanomaterials filling effect and durability of the AAC blocks. The usage of the graphene nanoplatelets (GNP) based soluble oil additives in the AAC block further enhance hydration process, thereby resulting in higher early strengths to AAC blocks and preventing breakages in the AAC blocks during both wet and dry stages. The usage of GNP based soluble oil further aid in enhancing binding strength by requiring comparatively lower quantity of binder usage. The GNP based soluble oil shows good thermal stability, and hence usage of the GNP based soluble oil in AAC blocks aid in increasing thermal stability, reducing thermal cracking, promoting durability and sustainability in AAC blocks. The usage of GNP based soluble oil enhances the reactivity of fly ash (element in AAC block) and accelerates the hydration process. Further, the usage of the GNP based soluble oil has led to a reduction in cement percentage by 10-15%.

Further, graphene-based nanomaterial additive improves compressive strength of the AAC blocks by lowering a water to powder ratio. The graphene-based nanomaterial additives achieve a compressive strength greater than 4 MPa after autoclaving with significantly lower cement content. Further, usage of the graphene-based nanomaterial additive enhances the cutting time and a quick setting time of AAC blocks by accelerating the hydration process. In the test it was found that, the cutting time is reduced by 30 to 45 minutes. Further, the AAC blocks with GNP based soluble oil show less block dry density. The compressive strength of the AAC blocks comprising GNP based soluble oil offers unparalleled sound insulation.

What is claimed is:

1. A method for preparing a soluble oil for an AAC (Autoclaved Aerated Concrete) block comprising:
preparing a metal hydroxide solution;
adding the prepared metal hydroxide solution to an acid slurry solution to obtain a first solution;
preparing a metal hydroxide aqueous solution; and
mixing the metal hydroxide aqueous solution with the first solution to obtain the soluble oil.

2. The method for preparing the soluble oil for the AAC block as claimed in claim 1, wherein a ratio of the metal hydroxide solution with respect to the acid slurry solution is 1:3 or 1:2.5 or 1:2.

3. The method for preparing the soluble oil for the AAC block as claimed in claim 1, wherein the soluble oil comprises 10-15 wt % of the metal hydroxide aqueous solution, wherein the metal hydroxide aqueous solution contains 10-15% of the metal hydroxide by weight and 85-90% of water by weight.

4. The method for preparing the soluble oil the AAC block as claimed in claim 1, wherein the metal hydroxide aqueous solution is mixed with the first solution using a mixer operating at a speed of 100 rpm to obtain the soluble oil.

5. The method for preparing the soluble oil for the AAC block as claimed in claim 1, wherein the soluble oil is kept at a steady state for a time period in the range of 10-15 minutes.

6. A method for preparing a graphene nanoplatelets (GNP) based soluble oil for an AAC (Autoclaved Aerated Concrete) block comprising:
preparing a first batch of a soluble oil;
preparing a second batch of the soluble oil;
mixing the first batch of the soluble oil with the second batch of the soluble oil to obtain a second mixture;
adding a tri-sodium orthophosphate solution to the second mixture to obtain a third mixture;
adding graphene nanoplatelets to the third mixture to obtain a fourth mixture; and
obtaining the GNP based soluble oil by adding a water-soluble acrylic resin solution to the fourth mixture.

7. The method for preparing the GNP based soluble oil as claimed in claim 6, wherein the first batch of the soluble oil and the second batch of the soluble oil are obtained by:
preparing a metal hydroxide solution;
adding the prepared metal hydroxide solution into an acid slurry solution to obtain a first solution;
preparing a metal hydroxide aqueous solution; and
mixing the metal hydroxide aqueous solution with the first solution to obtain the soluble oil.

8. The method for preparing the GNP based soluble oil as claimed in claim 7, wherein the first batch of the soluble oil is continuously mixed at a speed of 100 rpm using a mixer for about 5 minutes.

9. The method for preparing the GNP based soluble oil as claimed in claim 8, wherein, the first batch of the soluble oil is mixed with the second batch of the soluble oil at a speed of 150 rpm using the mixer for around 10 minutes to obtain a second mixture.

10. The method for preparing the GNP based soluble oil as claimed in claim 9, wherein 2-4 wt % of tri-sodium orthophosphate solution is mixed with the second mixture at a speed of 200 rpm using the mixer to obtain a third mixture.

11. The method for preparing the GNP based soluble oil as claimed in claim 10, wherein 10-15 wt % of the GNP is mixed with the third mixture at a speed of 250 rpm using the mixer for about 30-45 minutes to obtain a fourth mixture.

12. The method for preparing the GNP based soluble oil as claimed in claim 11, wherein the fourth mixture is kept at a steady state for a time period of about 15 minutes, and wherein 15-20 wt % of a water-soluble acrylic resin is added to the fourth mixture.

13. The method for preparing the GNP based soluble oil as claimed in claim 12, wherein the fourth mixture is mixed with the water-soluble acrylic resin at a speed of 300 rpm using the mixer for a time period of 30-45 minutes to obtain the GNP based soluble oil.

14. An AAC (Autoclaved Aerated concrete) block comprises:
cement in the range of 150-335 Kg/L;
lime in the range of 95-240 Kg/L;
fresh slurry in the range of 1320-2200 Kg/L;
return slurry in the range of 450-800 Kg/L;
fresh slurry dry in the range of 879-1500 Kg/L;
return slurry dry in the range of 251-375 Kg/L;
gypsum in the range of 20-25 Kg/L;
aluminum in the range of 0.8-2.1 Kg/L;
water in the range of 0-36 Kg/L;
soluble oil in the range of 0-2 Kg/L; and
graphene nanoplatelets based soluble oil in the range of 1-1.5 Kg/L.

15. The AAC block as claimed in claim 14, wherein the AAC block comprising the GNP based soluble oil comprises nanosized calcium silicate hydrate (CSH) microstructures, wherein the nanosized CSH microstructures comprises a rod-like morphology or needle-like morphology.

16. The AAC block as claimed in claim 15, wherein the AAC block comprising the GNP based soluble oil comprises a compressive strength ranging from 4-6 MPa.

17. The AAC block as claimed in claim 14, wherein the AAC block comprises fly ash, wherein the fly ash and the cement comprise silica, wherein the GNP based soluble oil converts the silica in the cement and the fly ash into a calcium silicate hydrate (CSH) to increase the compressive strength of the AAC block and to reduce water absorption in the AAC block.
